(19) United States
(12) Patent Application Publication
(10) Pub. No.: US 2026/0370262 A1
(43) Pub. Date: Nov. 19, 2026

(54) COVERAGE-ENHANCING DEVICE WITH FLEXIBLY OPERATED ANTENNA PANEL

(71) Applicant: Sony Group Corporation, Tokyo (JP)

(72) Inventors: Kun ZHAO, Malmö (SE); Fredrik RUSEK, Eslöv (SE); Erik BENGTSSON, Eslöv (SE); Jose FLORDELIS, Lund (SE); Olof ZANDER, Södra Sandby (SE); Zhinong YING, Lund (SE); Johan HILL, Lund (SE)

(21) Appl. No.: 19/136,764

(22) PCT Filed: Nov. 10, 2023
(86) PCT No.: PCT/EP2023/081390

§ 371 Date: Jun. 6, 2025

(30) Foreign Application Priority Data
Dec. 21, 2022 (SE) 2251542-3

(51) Int. Cl. H04B 7/04; H04B 7/06; H04B 7/08

(52) U.S. Cl. CPC H04B 7/04013; H04B 7/0691; H04B 7/0874

(57) ABSTRACT

A coverage-enhancing device (20) for use in a wireless network, the coverage-enhancing device comprising: a first panel system (50) comprising a plurality of sub-panels, each sub-panel comprising an array of configurable antenna elements, wherein the panel system comprises: a first sub-panel (51) configurable for reception, Rx; a second sub-panel (52) configurable for transmission, Tx; an auxiliary sub-panel (53); an amplifying circuit (55) connecting the first sub-panel to the second sub-panel to form a sub-panel combination for Rx and Tx; and a control unit (210) configured to selectively configure the auxiliary sub-panel to cooperate with one of the first and second sub-panels.

### TECHNICAL FIELD

This disclosure is related to solutions in the context of wireless communication between radio nodes of a wireless system, such as between different wireless devices or between a wireless device and an access node of a wireless network. Specifically, solutions are provided for a coverage-enhancing device, operable to relay communication between radio nodes.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication. In various scenarios, the UE may be configured to communicate directly with another wireless device. This may for certain applications be referred to as sidelink communication in 3GPP specifications.

In order to increase or improve coverage of a wireless network, a coverage-enhancing device may be employed. This may e.g. be the case near a cell edge, or where an environment causes problems of maintaining a sufficiently strong or reliable access link between the wireless network and wireless devices. The coverage-enhancing device is a device configured to forward radio signals. In some realizations, the coverage-enhancing device may be a passive device, configured to reflect or possibly redirect, an incoming signal. Alternatively, the coverage-enhancing device may be configured to amplify and transmit a received radio signal. In either case, the coverage-enhancing device is configured to receive a signal from a first direction and transmit a signal in a second direction. Various types of coverage-enhancing devices are occasionally referred to as smart repeaters (SR), which can be thought of as a traditional relay node but where some intelligence is added. In particular, such a coverage-enhancing device may be capable of performing beamforming, both in the direction of the transmitting radio node(s) and in the direction of the receiving radio node(s). Other terms used to denote examples of a coverage-enhancing device includes Reconfigurable Intelligent Surface (RIS), Large Intelligent Surface (LIS), Network Controlled Repeater (NCR), and NR (New Radio) repeater.

The typical use case for a coverage-enhancing device is to provide coverage extensions and, therefore, they are thought of as having two antenna arrays. A first array is directed towards an access node, e.g. a gNB, and a second array is directed towards a zone where coverage is low. However, using fixed panel sizes and common amplifiers for DL and UL, respectively, means that the maximum aperture and amplifier gain cannot be changed.

### SUMMARY

In view of the foregoing, solutions are presented herein for a coverage-enhancing device which overcomes one or more problems associated with the state of the art. According to one aspect, the proposed solution provides low complexity design which provides flexibility to operation of the coverage-enhancing device. The invention is defined by the independent claims.

According to one aspect, the proposed solution relates to a coverage-enhancing device, comprising:
a first panel system comprising a plurality of sub-panels, each sub-panel comprising an array of configurable antenna elements, wherein the panel system comprises:
   a first sub-panel configurable for reception, Rx;
   a second sub-panel configurable for transmission, Tx;
   an auxiliary sub-panel;
   a circuit connecting the first sub-panel to the second sub-panel to form a sub-panel combination for Rx and Tx; and
   a control unit configured to selectively configure the auxiliary sub-panel to cooperate with one of the first and second sub-panels.

By means of the proposed solution, a coverage-enhancing device is obtained where a sub-panel can be flexibly allocated such as it is switched to be either part of the Tx or the Rx sub-panel, or be disconnected from both. This provides an efficient way, in terms of implementation size and associated cost, to control the beam pattern towards, e.g., an access node and UEs for an active coverage-enhancing device.

### BRIEF DESCRIPTION OF THE DRAWINGS

FIG. 1 schematically illustrates an implementation of a wireless communication system, in which a UE communicates with a radio node, such as an access node of a wireless network, over a coverage-enhancing device.

FIG. 2 schematically illustrates a coverage-enhancing device configured to operate with the wireless network according to various examples.

FIG. 3 schematically illustrates various circuitry of an active coverage-enhancing device for single direction operation.

FIG. 4 schematically illustrates a double implementation of an active coverage-enhancing device corresponding to FIG. 3, for duplex operation FIG. 5 schematically illustrates various circuitry of an active coverage-enhancing device according to one example of the proposed solution.

FIG. 6A shows an image of simulated far-field Rx and Tx beam patterns for a DL operation of a CED of FIG. 5 in accordance with a first configuration.

FIG. 6B schematically illustrates deployment in accordance with the first configuration.

FIG. 7A shows an image of simulated far-field Rx and Tx beam patterns for a DL operation of a CED of FIG. 5 in accordance with a second configuration.

FIG. 7B schematically illustrates deployment in accordance with the second configuration.

FIG. 8 schematically illustrates circuitry associated with an example of a full duplex implementation of the proposed solution.

FIG. 9 shows images of simulated far-field Rx and Tx beam patterns for operation of a CED according to FIG. 8.

FIGS. 10A and 10B schematically illustrate another example of the proposed solution, where duplex operation is obtained by reversing amplification direction, wherein these two drawings show configuration of different amplification direction.

FIG. 11A shows an example of a reversing circuit for use in various examples of the proposed solution.

FIG. 11B shows an alternative example of a reversing circuit for use in various examples of the proposed solution.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

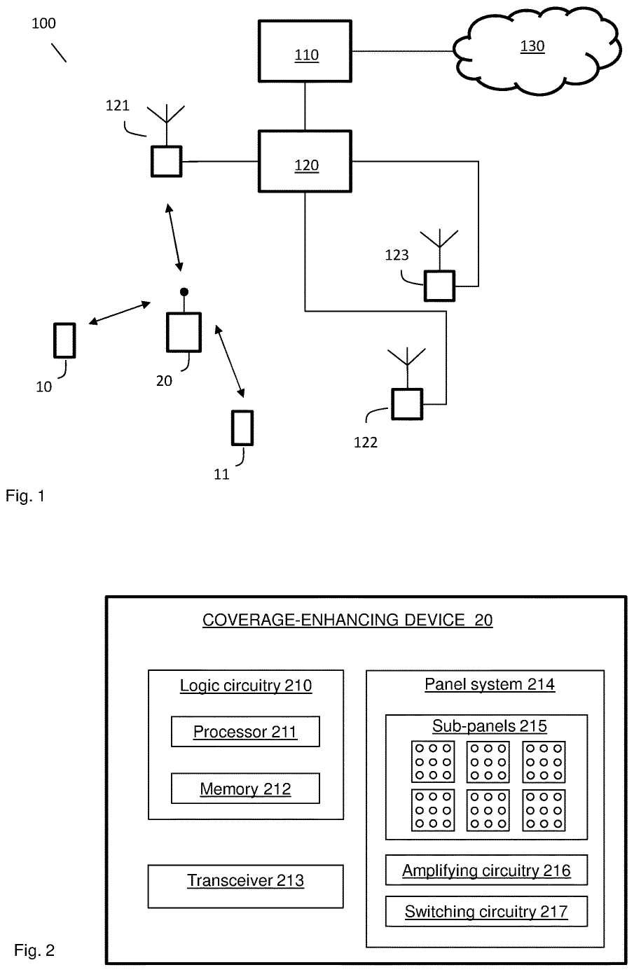

FIG. 1 illustrates a high-level perspective of operation in a wireless system, wherein a UE 10 is configured to communicate with a wireless network 100. The wireless network 100 may be a radio communication network 100, configured to operate under the provisions of technical specifications specified by 3GPP, such as for LTE, 5G NR or any future releases, according to various examples outlined herein. The wireless network 100 may comprise a core network 110, which in turn may comprise a plurality of core network nodes. The core network is connected to at least one access network 120 comprising one or more base stations or access nodes, of which access nodes 121-123 are illustrated. Each access node 121-123 is a radio node configured for wireless communication on a physical channel with various UEs, of which UEs 10 and 11 are shown. The core network 110 may in turn be connected to other networks 130.

A coverage-enhancing device 20, abbreviated CED going forward, is configured to operate in the wireless network 100, to repeat signals between various radio nodes of the wireless system, such as between the wireless network and at least one wireless device, or between wireless radio nodes such as between two UEs. The CED 20 may in this context be configured by the wireless network 100, such as by a hosting access node 121, to operate in accordance with a certain UL/DL scheme, e.g. according to a TDD scheme or pattern, and within a certain frequency range.

Before discussing further details and aspects of the proposed method, functional elements for the CED 20 configured to carry out the proposed solution, will be briefly discussed.

FIG. 2 schematically illustrates an example of the coverage-enhancing device 20 for use in a wireless network 100 as presented herein, and for carrying out various method steps as outlined. It may be noted that the drawing indicates functional elements of the CED 20, and that various aspects and features of those elements may be partly or fully realized by hardware elements, executed software, or a combination thereof.

The CED 20 comprises logic circuitry 210 which acts as a control unit for the CED. The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the CED 20 to carry out any of the method steps as provided herein. Software defined by said computer program code may include an application or a program that provides a function and/or a process. The software may include device firmware, an operating system (OS), or a variety of applications that may execute in the logic circuitry 210.

The CED device 20 may further comprise a transceiver 213 for communicating with other entities of the radio communication network 100, such as with the access node 121. The transceiver 213 may thus be configured to communicate, via the radio transceiver, with a hosting node of the wireless network 100, such as the access node 121. The logic circuitry 210 may be configured to encode and decode control signaling within communication with the wireless network 100.

The coverage-enhancing device 20 further comprises a panel system 214, comprising a plurality of subpanels 215. Each sub-panel 215 comprises an array of configurable antenna elements for direction sensitive operation, such as in different beams in transmission and/or reception. The panel system 214 may further comprise amplifying circuitry 216, operable for selectively amplifying a signal received in at least one sub-panel and delivering the amplified signal to at least one other sub-panel. The panel system 214 may further comprise switching circuitry 217, for selectively configuring connection of at least one sub-panel with another sub-panel of the panel system 214. In some examples, the panel system comprises a first panel system for UL operation and a second panel system for DL operation. Examples of further configuration and operation of the panel system will be described below.

The logic circuitry 210 may be configured to control the CED 20 based on control information which is stored in memory 212 or received in control signals by transceiver 213. Such control information may be associated with a TDD configuration for UL/DL switching, and information for controlling the antenna panel system 214. Such controlling may refer to beamforming configuration, connection switching of sub-panels 215, etc.

Obviously, the CED 20 may include other features and elements than those shown in the drawing or described herein, such as a power supply, a casing, sensors, etc., but these are left out for the sake of simplicity. Some features described above may also not be required, depending on the specific implementation of the CED 20. For example, some CEDs 20 may not include amplifying circuitry 216 and, therefore, may also not include switching circuitry 217. It may thus be noted that a connecting circuit without amplification may be employed to connect a first sub-panel to a second sub-panel to form a sub-panel combination for Rx and Tx. Further features and functions of the CED 20 will be discussed below.

A CED, such as a RIS, can be used to increase the network coverage by controlling the reflection coefficient of the reflected signals, so that signals at a plurality of antenna elements can be added in phase at the desired position. However, the gain of the reflected signal will be limited by the aperture size and the aperture efficiency if a purely passive RIS is used. In real life, the aperture size of the RIS may be limited due to the cost and installation space, while the aperture efficiency is highly affected by the wavefront of the incoming signal. One solution to overcome the gain limitation due to the aperture size/efficiency of RIS is to introduce power amplifiers, e.g., Power Amplifier (PA) or Low Noise Amplifier (LNA), in the RIS to amplify the reflected signals. However, adding amplifiers is not straightforward as self-oscillations may happen due to coupling between the input and output of the amplifiers and thus, to have a stable system, the possible gain in the amplifier is limited.

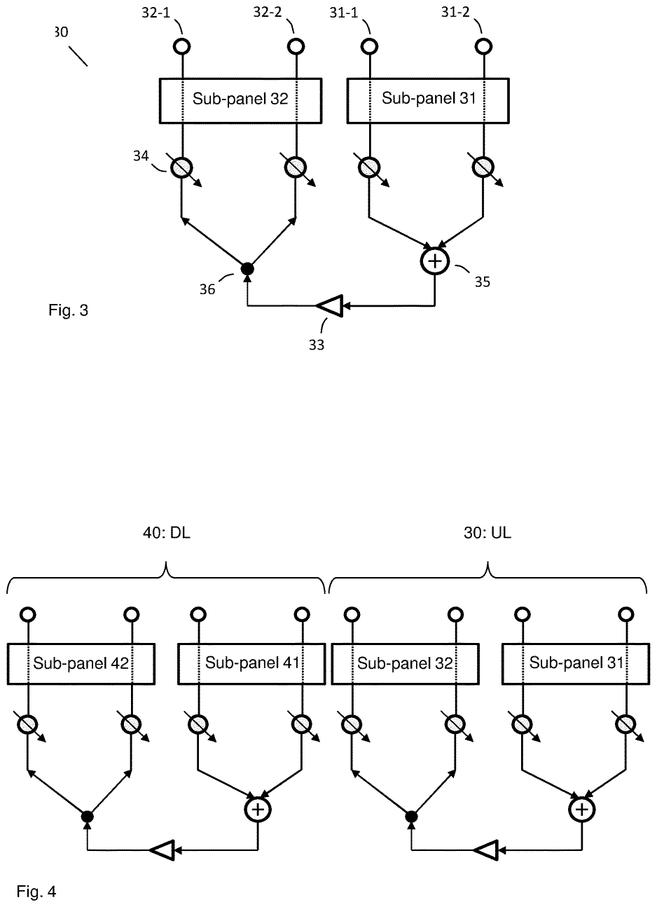

FIG. 3 schematically illustrates one solution that may be used for overcoming this problem, by separating the antenna panel or array into two sub-panels, where one sub-panel 31 is the receive (Rx) sub-panel, and the other sub-panel 32 is the transmit (Tx) sub-panel. An amplifier 33 is used to connect the two sub-panels 31, 32 into a panel pair 30, as illustrated in the drawing. Each sub-panel comprises a plurality of configurable antenna elements, but for the sake of simplicity only two antenna elements are shown per sub-panel: 31-1, 31-2 and 32-1, 32-2, respectively. Each antenna element is provided with a phase-shifting circuit 34 (only indicated for antenna element 32-1 in the drawing). This way, the respective antenna element is tunable, e.g., by application of a variable load impedance, to generate a phase shift for the purpose of obtaining combined direction sensitivity in the respective sub-panel. The antenna elements of the Rx sub-panel 31 are connected to an input end of the amplifier 33 over a combining circuit 35, and the antenna elements of the Tx sub-panel 32 are connected to an output end of the amplifier 33 over a splitting circuit 36. By this design, coupling between the input and output of the amplifier can be minimized, and the gain of the amplifier 33 can be significantly higher.

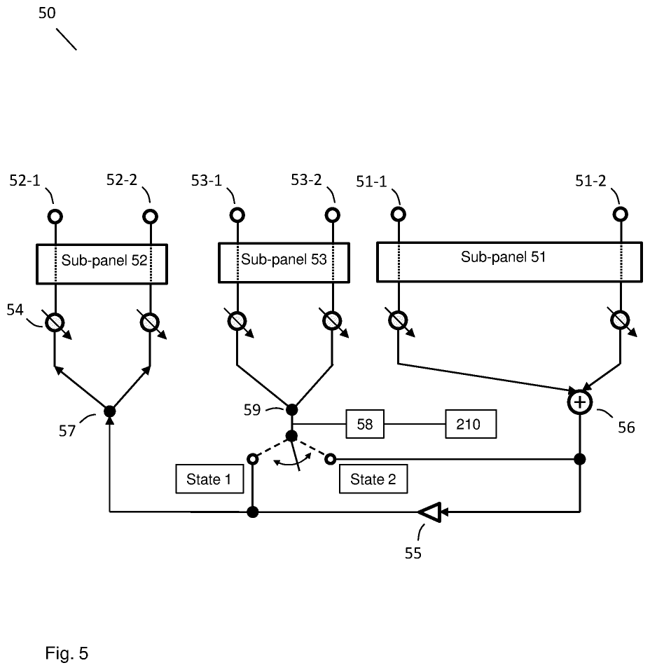

The design of FIG. 3 is limited to single-direction communication at each time (only DL or UL). To enable the full duplex operation, it is possible to have an additional sub-panel pair 40 that can communicate in the opposite direction. FIG. 4 illustrates a possible implementation and deployment in accordance with FIG. 3. Herein, one sub-panel pair 40 is responsible for DL, and the other sub-panel pair 30 is responsible for UL, when used for communication between a UE 10 and the access node 121 (or in first and second sidelink directions when conveying signals between UE 10 and UE 11). Details of the sub-panel pair 40 may correlate with those of the sub-panel pair 30, and reference signs for such details are left out in FIG. 4. By way of example implementation and with reference to FIG. 1, the panel system of FIG. 4 may be configured, using the phase-shifting circuits, such that:
Sub-panel 31 handles Rx from a first direction (from UE 10);
Sub-panel 32 handles Tx of amplified signals from sub-panel 31 in a second direction (to the access node 121 or UE 11);
Sub-panel 41 handles Rx from the second direction (from access node 121 or UE 11);
Sub-panel 42 handles Tx of amplified signals from sub-panel 41 in the first direction (to the UE 11);

However, the designs outlined with reference to FIGS. 3 and 4 have fixed panel sizes and common amplifiers for DL and UL, respectively. In particular, the maximum aperture and amplifier gain cannot be changed. Contrary to the constraints of these solutions, it is a great advantage to have better flexibility, considering a deployment scenario with an arbitrary number and location of UEs.

For this purpose, a novel architecture of active CED design is proposed, where the Tx and Rx sub-panel sizes are reconfigurable in a simple, efficient, and cost-effective way.

According to one aspect, the proposed solution relates to a CED 20 for use in a wireless network 100, the CED 20 comprises:
a first panel system comprising a plurality of sub-panels, each sub-panel comprising an array of configurable antenna elements, wherein the panel system comprises:
   a first sub-panel configurable for reception, Rx;
   a second sub-panel configurable for transmission, Tx;
   an auxiliary sub-panel;
   a circuit connecting the first sub-panel to the second sub-panel to form a sub-panel combination for Rx and Tx; and
   a control unit configured to selectively configure the auxiliary sub-panel to cooperate with one of the first and second sub-panels.

A technical effect of the proposed solution is that it facilitates reconfiguration of the CED for different scenarios with a low complexity solution, for example where it is beneficial to use a wide beam towards UEs when UEs are near the CED or for covering multiple UEs simultaneously.

By way of example, various aspects of the proposed solution will be described with reference to FIG. 5. This drawing indicates an example of the proposed solution for single-direction communication, i.e., for conveying radio signals from a first direction to a second direction. Further features related to duplex communication will be discussed further below. In these examples, a panels system comprising an amplifying circuit is described, connecting the first sub-panel to the second sub-panel. In alternative examples, the connecting circuit may be configured without amplifier.

FIG. 5 illustrates a panel system 50, comprising a first sub-panel 51, a second sub-panel 52, and an auxiliary sub-panel 53. Each sub-panel comprises a plurality of configurable antenna elements, but for the sake of simplicity only two antenna elements are shown per sub-panel: 51-1, 51-2; 52-1, 52-2; and 53-1, 53-2, respectively. Each antenna element is provided with a phase-shifting circuit 54 (only indicated for antenna element 52-1 in the drawing). This way, the respective antenna element is tunable, e.g., by application of a variable load impedance, to generate a phase shift for the purpose of obtaining combined direction sensitivity in the respective sub-panel.

An amplifying circuit, or amplifier for short, 55 is implemented to connect the sub-panels 51 and 52, as illustrated in the drawing. The antenna elements of the sub-panel configured for Rx, sub-panel 51 in the shown example, are connected to an input end of the amplifier 55 over a combining circuit 56, and the antenna elements of the sub-panel 52 configured for Tx are connected to an output end of the amplifier 55 over a splitting circuit 57.

A control unit, which may be realized by the logic circuitry 210, is configured to selectively configure the auxiliary sub-panel 53 to cooperate with one of the first 51 and second 52 sub-panels. The auxiliary sub-panel 53 is thus introduced between the sub-panels 51, 52 configured for Rx and Tx, to be flexibly allocated between Rx and Tx. A switching circuit 58 is introduced so that the auxiliary sub-panel 53 can be either connected before the amplifier 55, to an input end of the amplifier 55, or after, to an output end of the amplifier 55. This way, the auxiliary sub-panel 53 can be configured to either be part of the Rx sub-panel or part of Tx sub-panel, i.e. only be part of (at most) one of the Rx and Tx panels. By doing this, the beam pattern for Rx and Tx, and in particular the beamwidths, can be changed flexibly. Dependent on whether the auxiliary sub-panel 53 is used for Rx or Tx, a circuit 59 either acts as a signal combiner or a signal splitter, respectively, for the antenna elements 53-1, 53-2. In one example, the control unit 210 is further capable of optionally controlling the switching circuit 58 to selectively disconnect the auxiliary sub-panel from both the first and second sub-panels. Moreover, the antenna elements 53-1, 53-1 of the flexible sub-panel are configured jointly with the either the antenna elements 51-1, 51-2 of the first sub-panel 51, or the antenna elements 52-1, 52-2 of the second sub-panel 52.

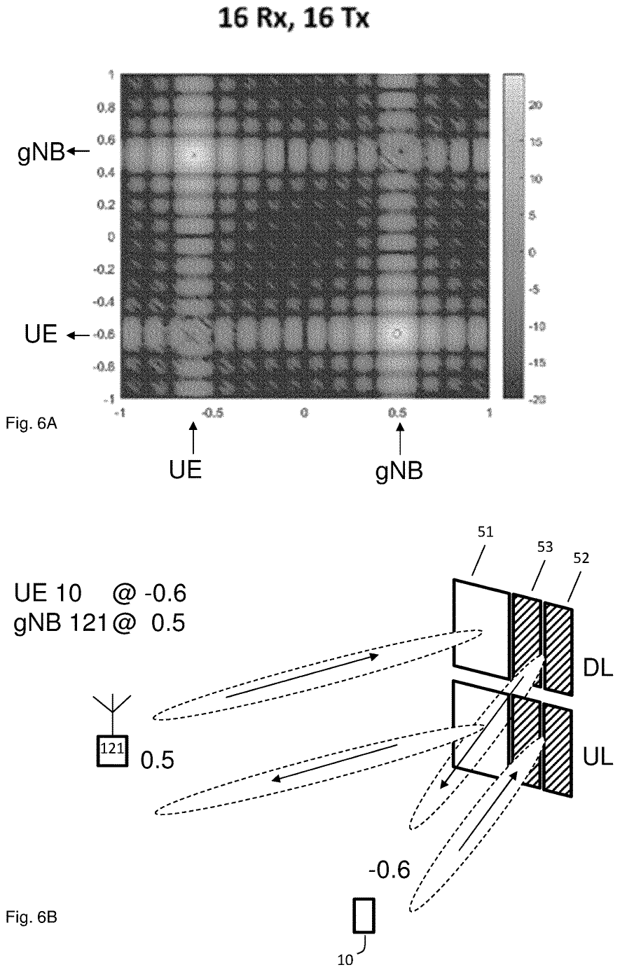

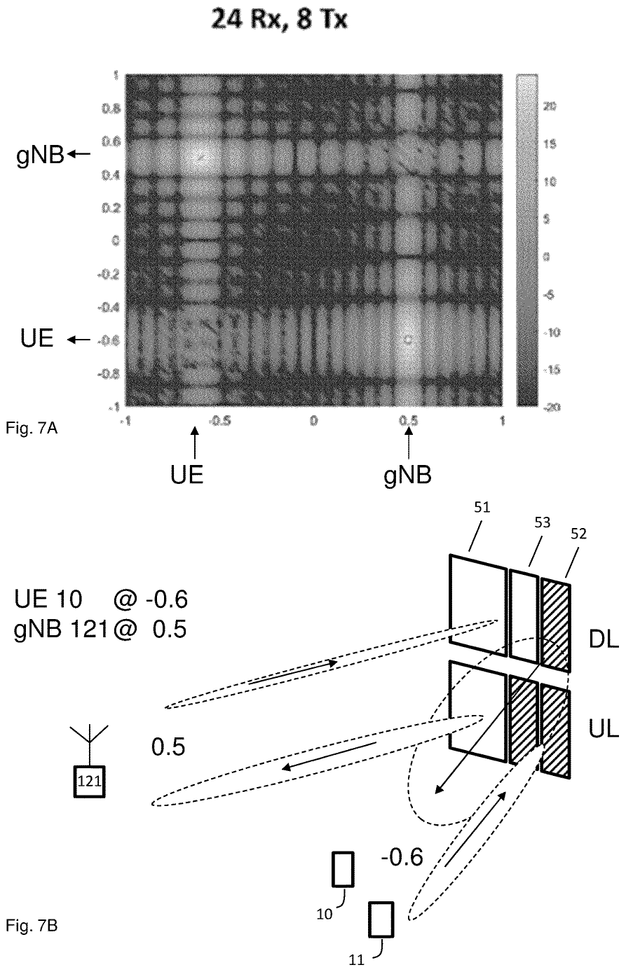

FIGS. 6A and 7A show images of results of simulated far-field Rx and Tx beam patterns for DL operation of a panel system with a total of 32 elements and a UL operation of a panel system with as many elements, with the corresponding deployment shown in FIGS. 6B and 7B. It may be noted that these drawings may refer to implementation of two panel systems, for DL and UL respectively, or alternative operation in DL or UL of the same panel system.

It may further be noted that the structure in FIGS. 6B and 7B would, in reality, generate a 4-dimensional radiation pattern (two input angles, and two output angles). The image in FIGS. 6A and 7A are the result of a remedy example simulation, where a linear array is assumed (i.e., 32 antennas arranged on a line) such that there is only a single input angle and a single output angle. In this context, these angles are defined as the angle between the direction and a perpendicular line to the linear array. The vertical axes indicate the sine of the transmission angle (i.e. sin (angleₒᵤₜ)), whereas the horizontal axes indicate the sine of the reception angle (i.e. sin (angleᵢₙ)).

In these examples, the sub-panels are provided such that the first sub-panel 51 comprises 16 antenna elements, whereas the second sub-panel 52 and the auxiliary sub-panel 53 each comprise 8 elements. Conceptually, any proportion could do. Implementation-wise, equally large antennas (sub-panels) are easier to deal with, to obtain equal power per antenna element. The problem is to split the power in the splitter, the split ratio should be the same as the array ratio. From a receive perspective the powers add, and size difference does not matter. Equal panel surface for Rx and Tx, as in FIGS. 6A and 6B is, arguably, the typical case and is what would be fabricated for a non-flexible system. The given proportion includes this normal case, as well as the option to obtain a more focused/defocused case (discussed with reference to FIGS. 7A and 7B).

The example of FIGS. 6A and 6B relates to a configuration where the auxiliary sub-panel 53 is configured to cooperate with the second sub-panel 52 in Rx and Tx, i.e. in both UL and DL. This configuration corresponds to turning switching circuit 58 to the left in FIG. 5, to assume State 1.

In the example of FIGS. 7A and 7B, a different configuration is employed in DL and UL. Specifically, the auxiliary sub-panel 53 is configured to cooperate with the first sub-panel 51 in Rx during DL operation. This configuration corresponds to turning switching circuit 58 to the right in FIG. 5, to assume State 2. By this configuration, only the second sub-panel 52 is used for Tx in DL, wherein a comparatively wide Tx beam is obtained, whereas a narrow Rx beam is obtained. In the illustrated UL configuration, the auxiliary sub-panel 53 is configured as in FIG. 6B to cooperate with the second sub-panel 52 in Rx. This configuration corresponds to the switching circuit 58 assuming State 1. This configuration may be beneficial to assume, since there may be high uncertainty in the angle towards the UE(s) 10, 11, but less so towards the access node 121.

The proposed solution thus offers flexibility in beam-shaping, which may be configured dependent on the need or requirement, such as distance of the UEs from the CED 20, and/or number of UEs to serve, and/or energy conservation requirements. It may be noted that a similar effect could be achieved with an individual amplifier or switch for each element to turn off some elements to control the beam width. However, compared to the proposed solution our invention, such implementations lead to a higher complexity and associated cost as more components would be needed. Also, it would obtain lower aperture efficiency since some elements need to be switched off, compared to the proposed solution where the full aperture is we always used, but re-distributed between Tx and Rx. Therefore, the proposed design is more efficient both economy-wise and size-wise.

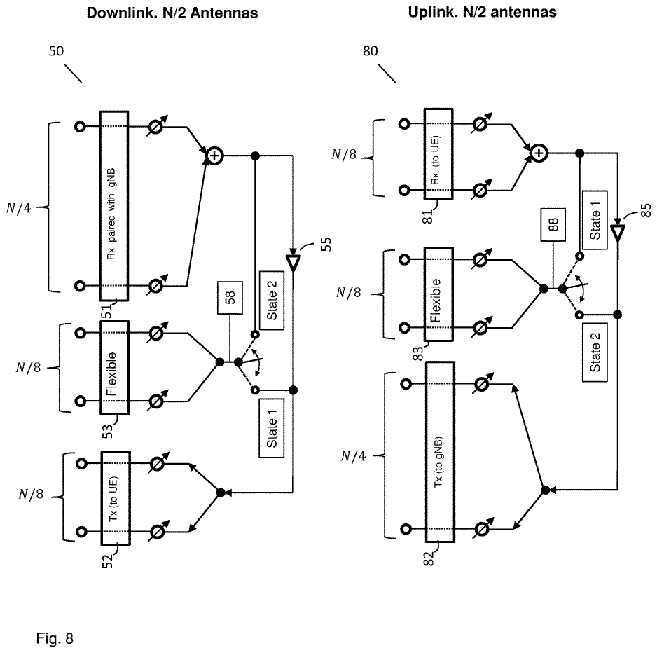

FIG. 8 schematically illustrates an example of the proposed solution. Herein, corresponding to the design discussed with reference to FIG. 4, the proposed solution according to FIG. 5 is in various examples configured to support full duplex operation by adding a second panel system comprising corresponding sub-panels. Specifically, in addition to the DL configuration of FIG. 5, a second panel system comprising a sub-panel group is provided for the UL.

To the left in the drawing, the basic elements and circuitry for the first panel system 50 for the DL part is shown, corresponding to FIG. 5. To the right, the basic elements and circuitry for the corresponding second panel system 80 for the UL part is shown. For the sake of simplicity, reference signs are not provided to all features in FIG. 8, which correspond to those of FIG. 5. However, the drawing indicates the sub-panels 51, 52, 53 of the first panel system 50, and the corresponding sub-panels 81, 82, 83 of the second panel system. In addition, corresponding to the amplifying circuit 55 and switching circuit 58 of the first panel system 50, the second panel system 80 may comprise an amplifying circuit 85 and a switching circuit 88. The amplifying circuits 55, 85 may form part of amplifying circuitry 216, and switching circuits 58, 88 may form part of switching circuitry 217. Switching circuit 88 may assume State 1 or State 2 to selectively connect the auxiliary sub-panel to one of sub-panels 81 or 82, or to neither (leaving auxiliary sub-panel unused).

The first panel system 50 and the second panel system 80 are configured to thus convey radio signals in opposite Rx and Tx directions in the wireless network 100. In various examples, the configuration of the CED 20 according to FIG. 8 provides full degree of freedom to generate different beamwidth for DL/UL and Tx/Rx. In some examples, each panel system 50, 80 have fixed configuration of the respective first sub-panels 51, 81 in a first direction, such as in a direction to the access node 121, but oppositely configured for Rx and Tx, respectively. Correspondingly, the respective second sub-panels 52, 82 have fixed configuration in a second direction, such as in a direction to an area to cover where one or more UEs 10, 11 may be located, wherein the second sub-panels 52, 82 are also oppositely configured for Rx and Tx, respectively.

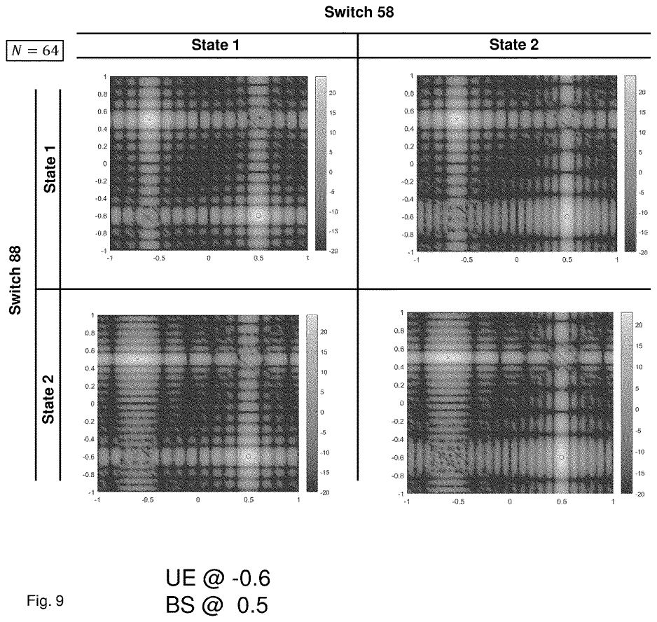

FIG. 9 shows images corresponding to FIGS. 6A and 7A, indicating results of simulated far-field Rx and Tx beam patterns for both DL and UL, using a panel system solution in accordance with FIG. 8 with N=64 antenna elements. Again, as was discussed with reference to FIGS. 6A and 7A, a linear array is assumed. The horizontal axis indicates sin (angleᵢₙ) and the vertical axis indicates sin (angleₒᵤₜ). These images illustrate the different obtainable beam patterns where the auxiliary sub-panels 53, 83 are selectively connected to one of the associated first 51, 81 or second 52, 82 sub-panel, in the different combinations of assumed States (1 or 2) of Switch 58 and 88, respectively. It may be noted that also these examples are provided for a pair of panel systems which both have one larger (16 antenna elements) sub-panel 51, 82, which may be configured fixed in the direction of the access node 121, and one smaller (8 antenna elements) sub-panel 52, 81, which may be configured fixed in the direction of an area to which capacity/coverage is to be extended for the access node 121. Toggling the respective switch 58, 88 to connect the respective auxiliary sub-panel 53, 83 to cooperate with one of the associated first or second sub-panel, and jointly configuring the antenna elements of the auxiliary sub-panel with the sub-panel it is connected to cooperate with, results in the illustrated beam patterns in the simulated example (with linear arrays being assumed).

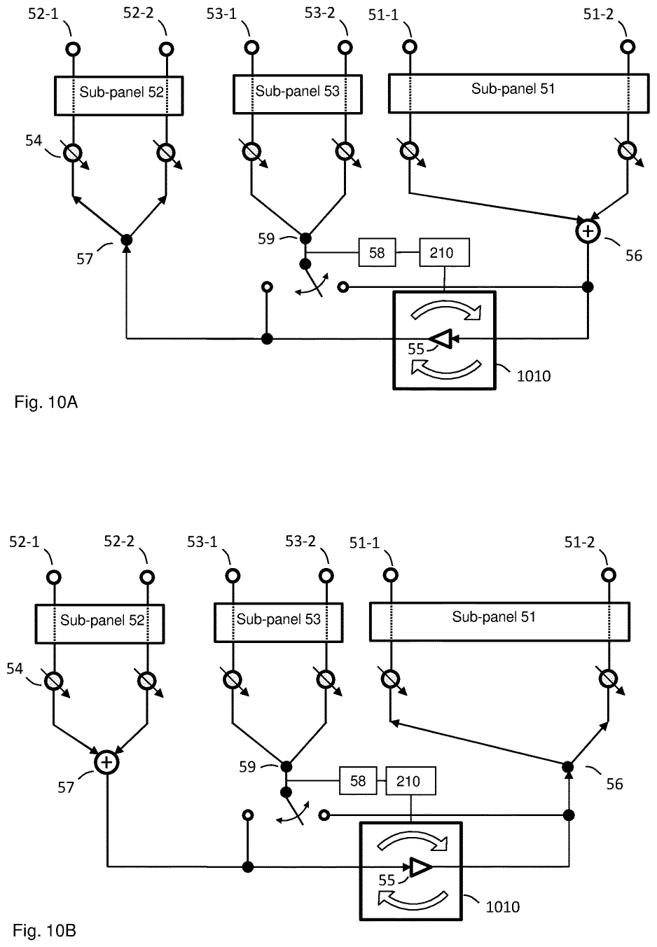

FIGS. 10A and 10B illustrate different settings of another example of the proposed solution. This example is based on the example provided with reference to FIG. 5, and the same reference numerals are used for corresponding feature. It may be noted that the different states of the switch 58 are not indicated in this drawing, but that these may be assumed in accordance with what has been described with reference to FIG. 5.

In addition to the example described with reference to FIG. 5, the CED 20 is configured to control amplifying direction of the amplifying circuit 55 in accordance with a TDD pattern, wherein Rx and Tx operation is reversed. This may be configured by the control unit, realized by the logic circuitry 210. This way, duplex operation is obtained with only one panel system.

In the setting shown in FIG. 10A, the panel system operates in accordance with the panel system of FIG. 5, e.g. in DL operation. The switching circuit 58 is controlled to connect the auxiliary sub-panel 53 to cooperate with either sub-panel 51 in Rx or sub-panel 52 in Tx.

According to a TDD pattern operated by the control unit, amplification direction of the amplifying circuit 55 is reversed, indicated in the drawing by a reversing circuit 1010. The TDD pattern may be predetermined and stored in memory 212, or received in a control signal by transceiver 213, e.g. from a hosting access node 121.

Upon reversal of the amplification direction, sub-panel 51 operates in Tx and sub-panel 52 operates in Rx, as shown in FIG. 10B. The antenna elements of the sub-panel 52 configured for Rx, are then connected to the input end of the amplifier 55, wherein circuit 56 acts as a splitting circuit. The antenna elements of the sub-panel 51 configured for Tx are connected to the output end of the amplifier 55 over a circuit 57, now acting as a combiner circuit. It may be noted that reversal of the amplification direction is functionally indicated in the drawing. This may be realized in various ways according to the state of the art.

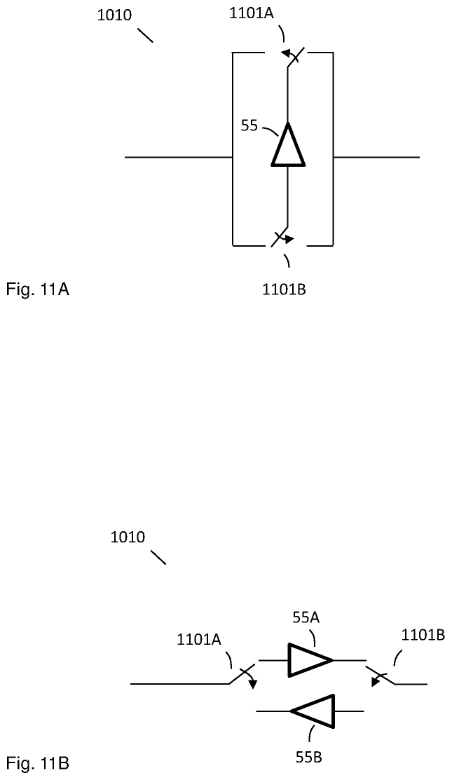

By way of example, FIG. 11A illustrates a reversing circuit 1010 comprising two switches 1101A and 1101B and a single amplifying line 55. Reversal of amplification direction is obtained by concurrently toggling both indicated switches 1101A and 1101B.

FIG. 11B illustrates another example of how to realize the reversing circuit 1010, also comprising two switches 1101A, 1101B, and two amplification lines 55A and 55B. Reversal of amplification direction is obtained by concurrently toggling both indicated switches 1101A and 1101B. This example provides the benefit of configuring different magnitude of amplification dependent on with which sub-panel the auxiliary sub-panel is configured to cooperate.

The switching circuit 58 is controlled to connect the auxiliary sub-panel 53 to cooperate with either of the two 51, 52 (or optionally with none of them). In some examples, the auxiliary sub-panel 53 is selectively configured to be connected to one of the sub-panels 51 and 52 and to remain connected to that sub-panel during reversal according to the TDD pattern. The control unit 210 is thereby configured to configure the antenna elements of the auxiliary sub-panel 53 jointly with the antenna elements of the sub-panel which it is connected to cooperate with, e.g. such that the antenna elements of both the auxiliary sub-panel 53 and e.g. the first sub-panel 51, or configured for a certain angle of arrival (AoA) for Rx or angle of departure (AoD) for Tx. Operation of the switching circuit 58 may thus be independent of the operation of the reversing circuit 1010. In such an example, the auxiliary sub-panel may thus be controlled to operate in a certain direction, such as either towards a UE or towards an access node (or another UE for coverage enhancement, such as in sidelink communication).

In an alternative arrangement, control of the switching circuit 58 and the reversing circuit 101 is synchronized, e.g. such that both switch according to a TDD schedule. In such an example, the auxiliary sub-panel 53 is configured to operate in one of Rx and TX during TDD operation. In such an embodiment, each switching operation also entails configuration of the antenna elements of the sub-panel 53, to adopt to the direction in which it operates. In this example. the control unit 210 is thereby configured to configure the antenna elements of the auxiliary sub-panel 53 jointly with the antenna elements of the sub-panel which it is currently connected to cooperate with, i.e. toggling between sub-panels 51 and sub 52 in accordance with the TDD pattern.

The proposed solution, and various alternative and optional implementation details have been outlined in the foregoing. These details and examples may be combined in any way that is not clearly contradictory, and in any form as provided in the following claims. The proposed solution provides a useful solution in the field of radio communication, specifically for enhancing capacity or coverage in a wireless system.

1. A coverage-enhancing device for use in a wireless network, the coverage-enhancing device comprising:
a first panel system comprising a plurality of sub-panels, each sub-panel comprising an array of configurable antenna elements, wherein the panel system comprises:
a first sub-panel configurable for reception, Rx;
a second sub-panel configurable for transmission, Tx;
an auxiliary sub-panel;
a circuit connecting the first sub-panel to the second sub-panel to form a sub-panel combination for Rx and Tx; and
a control unit configured to selectively configure the auxiliary sub-panel to cooperate with one of the first and second sub-panels.

2. The coverage-enhancing device of claim 1, wherein the circuit connecting the first sub-panel to the second sub-panel comprises an amplifying circuit.

3. The coverage-enhancing device of claim 1, wherein the panel system comprises:
a switching circuit, wherein the control unit is configured to control the switching circuit to selectively connect the auxiliary sub-panel to cooperate with the first subpanel or the second sub-panel.

4. The coverage-enhancing device of claim 2, wherein the switching circuit selectively connects the auxiliary sub-panel to an input end or an output end of the amplifying circuit.

5. The coverage-enhancing device of claim 3, wherein the control unit is configured to control the switching circuit to selectively disconnect the auxiliary subpanel from both the first and second sub-panels.

6. The coverage-enhancing device of claim 2, wherein each sub-panel comprises a connector circuit having a first end connected to each antenna element of the sub-panel and a second end for connection to the amplifier circuit.

7. The coverage-enhancing device of claim 1, wherein the control unit is configured to selectively configure the antenna elements of the auxiliary subpanel jointly with the antenna elements of one of the first and second sub-panels.

8. The coverage-enhancing device of claim 1, wherein the sub-panels are in parallel arrangement facing a common direction, with the auxiliary sub-panel arranged between the first sub-panel and the second sub-panel.

9. The coverage-enhancing device of claim 1, wherein the auxiliary sub-panel and at least the second sub-panel have a common number of antenna elements.

10. The coverage-enhancing device of claim 1, wherein the first subpanel is configured to fixed Rx operation and the second sub-panel is configured for fixed Tx operation.

11. The coverage-enhancing device of claim 1, comprising:
a second panel system, corresponding to the first panel system;
wherein the first panel system and the second panel system are configured to convey radio signals in opposite Rx and Tx directions in the wireless network.

12. The coverage-enhancing device of claim 2, wherein the control unit is configured to control amplifying direction of the amplifying circuit in accordance with a Time Division Duplex, TDD, pattern, wherein Rx and Tx operation is reversed.

13. The coverage-enhancing device of claim 12, comprising:
a reversing circuit for setting amplifying direction of the amplifying circuit.

14. The coverage-enhancing device of claim 1, comprising:
a control signal receiver, wherein the control unit is configured to selectively configure the first panel system based on a received control signal.
